(19) United States
(12) Patent Application Publication
(10) Pub. No.: US 2012/0293816 A1
(43) Pub. Date: Nov. 22, 2012

(54) PRINTING APPARATUS, PRINTING METHOD, PRINTING SYSTEM, AND COMPUTER READABLE MEDIUM

(75) Inventor: Tomohiko Bito, Yokohama-shi (JP)

(73) Assignee: CANON KABUSHIKI KAISHA, Tokyo (JP)

(21) Appl. No.: 13/449,245

(22) Filed: Apr. 17, 2012

(30) Foreign Application Priority Data
May 16, 2011 (JP) 2011-109614

(51) Int. Cl. G06F 3/12; G06K 15/02

(52) U.S. Cl. 358/1.13

(57) ABSTRACT

A printing apparatus comprises: a plurality of analysis units configured to correspond respectively to PDL types indicating a plurality of types of page description languages; a unit configured to determine one of the plurality of analysis units to be used for analysis processing, based on a PDL type of the PDL data; a unit configured, in a case where analysis processing is performed using the determined analysis unit and if the number of times that a specific command has been detected in a predetermined range of the PDL data exceeds a predetermined threshold value, to suspend the analysis processing for the PDL data and to issue an alert; a unit configured, after an alert has been issued, to accept an instruction indicating whether to continue or cancel the analysis processing for the PDL data.

### BACKGROUND OF THE INVENTION

1. Field of the Invention

The present invention relates to a printing apparatus that prints print data, a printing method, a printing system, and a computer readable medium.

2. Description of the Related Art

In recent years, it has become possible for anyone to easily transmit and output print data of documents or images from host computers, following the spread of various types of printing apparatuses. The print data can be various types of data generated depending on the type of printer driver selected by a host computer. However, the types of print data that can be analyzed by each printing apparatus are restricted depending on the function of the printing apparatus. If data that cannot be analyzed has been received and forcibly analyzed and printed, there is the problem that the print result is not the desired one due to the occurrence of garbled characters in an image or a failure during print processing.

As a system for preventing the above problem, a system has been disclosed in which, for example, a plurality of formats of page description languages (PDLs) are received and the data formats of the PDLs are distinguished. If a printer that executes printing has determined that data received is described in a PDL that cannot be processed or in a format other than the PDL format, printing of this print job will not be executed and the print job will be stored in a queue as a job being in a print hold state. Thereafter, the next print job is received, so that print processing is continuously performed without being interrupted (see Japanese Patent Laid-Open No. 2004-330688).

However, in conventional printing apparatuses, in the case where the type of PDL data is erroneously determined, garbling of characters or a failure in print processing will occur when executing processing on the PDL data, which results in waste of output paper or the occurrence of abnormal errors in the printing apparatuses.

### SUMMARY OF THE INVENTION

According to one aspect of the present invention, there is provided a printing apparatus that performs printing on PDL data described in a page description language, comprising: a plurality of analysis units configured to correspond respectively to PDL types indicating a plurality of types of page description languages; a determination unit configured to determine one of the plurality of analysis units to be used for analysis processing, based on a PDL type of the PDL data; an alerting unit configured, in a case where analysis processing is performed using the analysis unit determined by the determination unit and if the number of times that a specific command has been detected in a predetermined range of the PDL data exceeds a predetermined threshold value, to suspend the analysis processing for the PDL data and to issue an alert; an accepting unit configured, after an alert has been issued by the alerting unit, to accept an instruction indicating whether to continue or cancel the analysis processing for the PDL data; and a control unit configured to cancel the analysis processing if the accepting unit has accepted an instruction to cancel the analysis processing for the PDL data.

According to another aspect of the present invention, there is provided a printing system comprising a printing apparatus that performs printing on PDL data described in a page description language; and an external module, the printing apparatus including: a plurality of analysis units configured to correspond respectively to PDL types indicating a plurality of types of page description languages; a transmission unit configured to transmit the PDL data and information regarding the PDL types supported by the printing apparatus, to the external module; a reception unit configured to receive PDL data that has been converted by the external module into a PDL type that can be analyzed by one of the plurality of analysis units; and an execution unit configured to execute analysis processing using the analysis unit corresponding to the PDL type of the PDL data received by the reception unit, and the external module including: a conversion unit configured to convert the PDL data received from the printing apparatus into PDL data of a PDL type that can be analyzed by the printing apparatus, using the information regarding the PDL types transmitted from the printing apparatus; and a reply unit configured to transmit the PDL data converted by the conversion unit to the printing apparatus.

According to another aspect of the present invention, there is provided a printing method to be used in a printing apparatus that performs printing on PDL data described in a page description language, comprising: a plurality of analysis steps of performing analysis in correspondence respectively with PDL types indicating a plurality of types of page description languages used to describe PDL data; a determination step of determining in which one of the plurality of analysis steps analysis processing is to be performed, based on a PDL type of the PDL data; an alerting step of, in a case where analysis processing is performed in the analysis step determined in the determination step and if the number of times that a specific command has been detected in a predetermined range of the PDL data exceeds a predetermined threshold value, suspending the analysis processing for the PDL data and issuing an alert; an accepting step of, after an alert has been issued in the alerting step, accepting an instruction indicating whether to continue or cancel the analysis processing for the PDL data; and a control step of cancelling the analysis processing if an instruction to cancel the analysis processing for the PDL data has been accepted in the accepting step.

According to another aspect of the present invention, there is provided a printing method to be used in a printing system including a printing apparatus that performs printing on PDL data described in a page description language, and an external module, comprising: a plurality of analysis steps of performing analysis in correspondence respectively with PDL types indicating a plurality of types of page description languages used to describe PDL data; a transmission step of transmitting the PDL data and information regarding the PDL types supported by the printing apparatus, to the external module; a reception step of receiving PDL data that has been converted by the external module into a PDL type that can be analyzed in one of the plurality of analysis steps; and an execution step of executing analysis processing in the analysis step corresponding to the PDL type of the PDL data received in the reception step, the plurality of analysis steps, the transmission step, the reception step, and the execution step being performed by the printing apparatus, and the method further comprising: a conversion step of converting the PDL data received from the printing apparatus into PDL data of a PDL type that can be analyzed by the printing apparatus, using the information regarding the PDL types transmitted from the printing apparatus; and a reply step of transmitting the PDL data converted in the conversion step to the printing apparatus, the conversion step and the replay step being performed by the external module.

According to another aspect of the present invention, there is provided a computer readable medium storing a program for causing a computer to function as: a plurality of analysis units configured to correspond respectively to PDL types indicating a plurality of types of page description languages; a determination unit configured to determine one of the plurality of analysis units to be used for analysis processing, based on a PDL type of the PDL data; an alerting unit configured, in a case where analysis processing is performed using the analysis unit determined by the determination unit and if the number of times that a specific command has been detected in a predetermined range of the PDL data exceeds a predetermined threshold value, to suspend the analysis processing for the PDL data and to issue an alert; an accepting unit configured, after an alert has been issued by the alerting unit, to accept an instruction indicating whether to continue or cancel the analysis processing for the PDL data; and a control unit configured to cancel the analysis processing if the accepting unit has accepted an instruction to cancel the analysis processing for the PDL data.

According to the present invention, if an unexpected command has been issued a fixed number of times during execution of print job processing, it is possible to suspend the processing and select whether to continue or cancel the processing in accordance with a user input.

Further features of the present invention will become apparent from the following description of exemplary embodiments with reference to the attached drawings.

### BRIEF DESCRIPTION OF THE DRAWINGS

FIG. 1 is a diagram showing a configuration of a printing system.

FIG. 2 is a block diagram showing a configuration of a host computer and a printer.

FIG. 3 is a block diagram showing a software configuration.

FIG. 4 is a flowchart of processing performed by a printer according to a first embodiment.

FIG. 5 is a flowchart of processing performed by a printer according to a second embodiment.

FIG. 6 is a flowchart of processing performed by an external PDL analysis module according to the second embodiment.

FIG. 7 is a flowchart of processing performed by a printer according to a third embodiment.

### DESCRIPTION OF THE EMBODIMENTS

The following describes embodiments for implementing the present invention with reference to the drawings.

### First Embodiment

### System Configuration

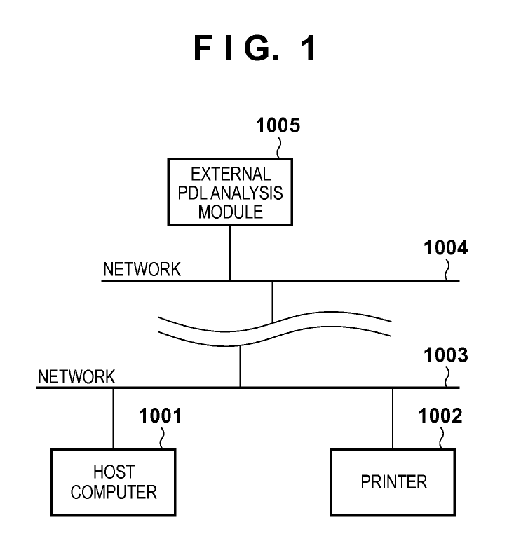

FIG. 1 is a configuration diagram of a printing system according to a first embodiment of the present invention. In the printing system in FIG. 1, a host computer 1001 converts document data or image data held therein into PDL data described in a page description language that can be analyzed by a printing apparatus or printer 1002 in order to expand an image, using a printer driver (not shown) mounted in the computer. Then, the host computer 1001 transmits the converted data to the printer 1002 via a network 1003. The printer 1002 analyzes the received PDL data, generates an expanded image, and performs print control so as to print the expanded image.

The host computer 1001 and the printer 1002 are connected to the network 1003, forming a configuration in which various types of data can be exchanged between the devices. Furthermore, a network 1004 different from the network 1003 is connected to the network 1003 via a rooter (not shown) or the like, forming a configuration in which various types of data can be exchanged between devices installed on the networks. An external PDL analysis module 1005 is installed on the network 1004. The external PDL analysis module 1005 may be realized by cloud computing, which is one type of services available on the Internet, for example. Details of the external PDL analysis module 1005 will be described later in a second embodiment.

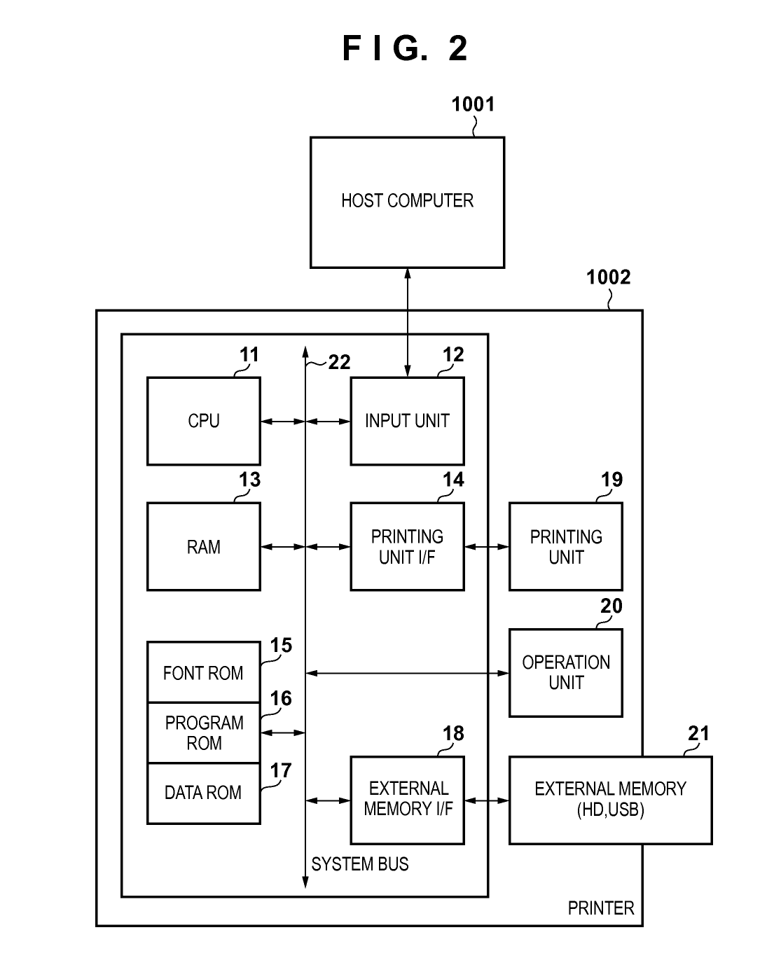

FIG. 2 is a block diagram showing a detailed configuration of the host computer 1001 and the printer 1002 described above. The host computer 1001 performs transmission/reception of PDL data via an input unit 12 of the printer 1002. The input unit 12 of the printer 1002 analyzes the leading portion of PDL data received from the host computer 1001, determines the type of a PDL (PDL type) used to describe the PDL data, and selects a PDL analysis program to be used to analyze the PDL data. The selection of a PDL analysis program described here will be discussed later.

The printer 1002 analyzes PDL data by a CPU 11 reading out a PDL analysis program stored in a program ROM 16 to a RAM 13 and executing that program. The printer 1002 also generates an expanded image using, for example, a font and pattern information stored in a font ROM 15 and a data ROM 17. The generated expanded image is transmitted to a printing unit 19 via a printing unit I/F 14, and the printing unit 19 prints and outputs the expanded image. Furthermore, various print settings relating to the expanded image can be changed through an operation unit 20, and it is also possible to define image processing settings for the printer 1002 in advance. The units in the printer 1002 are connected to one another via a bus 22.

The printer 1002 is also connected to an external memory 21 such as an HDD or a USB memory via an external memory I/F 18, and is capable of storing received PDL data or image data that has been expanded separately, in the external memory 21.

Software Configuration

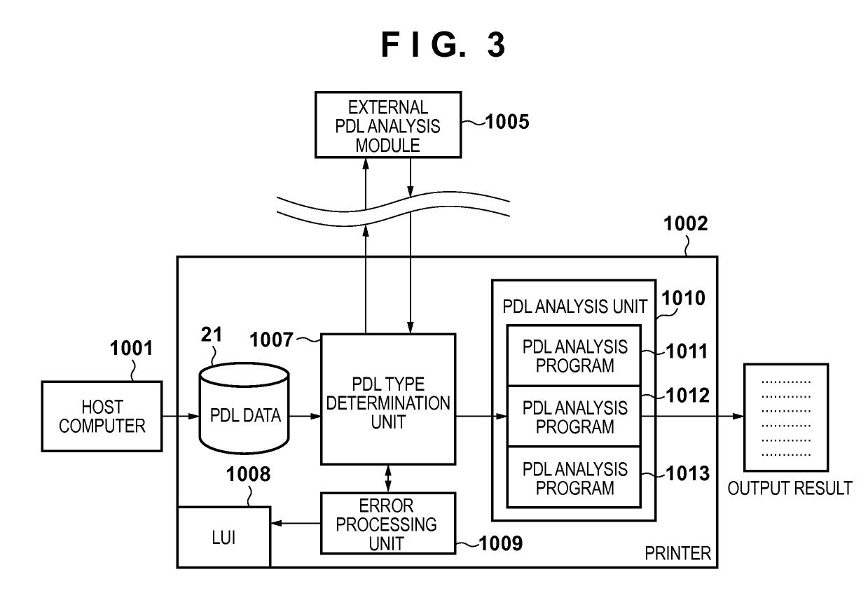

FIG. 3 is a block diagram showing a detailed software configuration according to the present embodiment. When PDL data is transmitted from the host computer 1001, the data is stored in the external memory 21 such as an HDD via the input unit 12 of the printer 1002. A PDL type determination unit 1007 performs analysis processing using a fixed data size on the stored PDL data so as to determine a PDL type format in which the PDL data is to be processed. Assume that the data size as used here is defined in advance.

A PDL analysis unit 1010 includes PDL analysis programs 1011, 1012, and 1013 corresponding respectively to PDL types. The PDL data is classified into one of a plurality of PDL types and analyzed using one of the PDL analysis programs 1011, 1012, and 1013 that corresponds to the PDL type. In the configuration shown in FIG. 3, the PDL analysis programs 1011, 1012, and 1013 corresponding to three PDL types are shown. The PDL analysis program corresponding to the determined PDL type is used to analyze the PDL data, and output processing is performed in accordance with the result of the analysis. The PDL analysis unit 1010 is also configured to be capable of using an error processing unit 1009 to notify a result of erroneous PDL determination through a local user interface (LUI) 1008 or the like.

Processing Flow

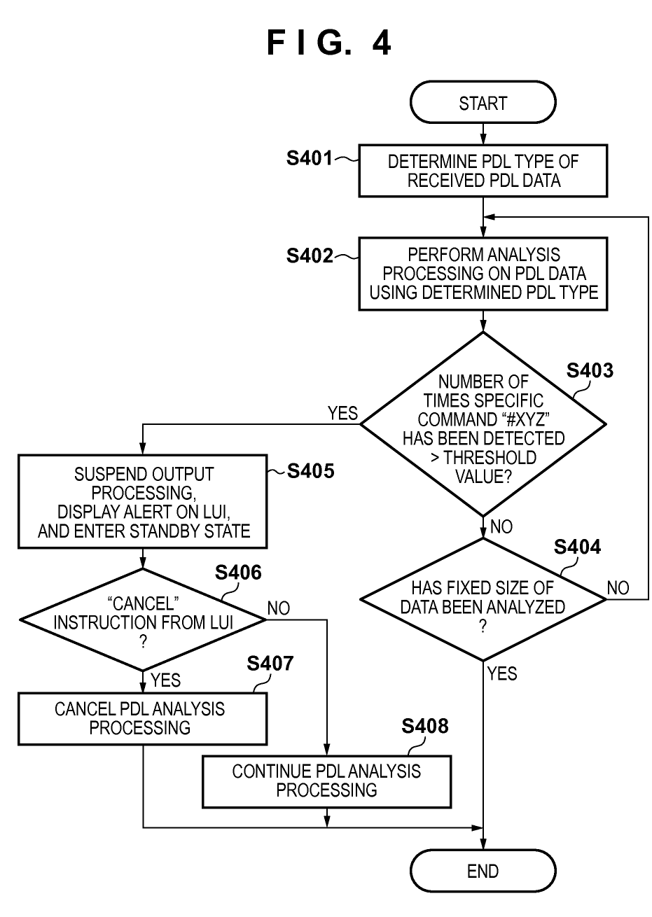

FIG. 4 is a flowchart illustrating a procedure of processing performed by the printer 1002 according to the present embodiment. This processing is realized by the CPU 11 reading out a program stored in the program ROM 16 or the like, which serves as a storage unit, and executing that program.

First, upon receipt of PDL data, the printer 1002 performs determination processing for determining which one of the aforementioned PDL analysis programs corresponding to the PDL types is to be used to perform processing on the PDL data (S401). Next, the printer 1002 performs analysis processing on the PDL data using the PDL analysis program corresponding to the selected PDL type, and performs determination processing for determining whether or not a specific command has been detected from the PDL data (S402). In the present embodiment, a case in which the specific command detected in this step is indicated using a character string “#XYZ” is given as an example. The term “specific command” as used herein refers to, for example, a command for which normal processing is impossible using a PDL analysis program corresponding to a given selected PDL type.

If the specific command “#XYZ” has been detected, the printer 1002 increments the number of times that the specific command has been detected, and determines whether or not that number exceeds a predetermined threshold value (S403). If the number of times that the specific command has been detected does not exceed the threshold value (NO in step S403), the printer 1002 counts the size of the received PDL data and determines whether or not a fixed data size (predetermined range) has been counted (S404). Assume here that the fixed data size in a fixed range has been defined in advance.

If the size of the PDL data exceeds the fixed data size (YES in step S404), the printer 1002 ends this procedure without performing the detection processing for detecting a specific command from PDL data on subsequently received PDL data. If the size of the PDL data does not yet exceed the fixed data size (NO in step S404), the printer 1002 returns to step S402.

If the number of times that the specific command has been detected exceeds the predetermined threshold value (YES in step S403), the printer 1002 suspends the analysis processing for the PDL data, and displays an alert indicating that an erroneous determination has been made when selecting the PDL type, on the LUI 1008 (step S405). Then, the printer 1002 enters a state in which it stands by for the reception of user key input on whether to “cancel” or “continue” the processing, through the LUI 1008 (S406). In the present embodiment, this LUI 1008 realizes an accepting unit.

If the user key input is an instruction to “cancel” the processing (YES in step S406), the printer 1002 cancels the analysis processing for the PDL data and ends this procedure (S407).

If the user key input is an instruction to “continue” the processing (NO in step S406), the printer 1002 continues the analysis processing for the PDL data, and ends this procedure when the analysis processing is completed (step S408).

Note that although the specific command may be set in advance, a configuration is also possible in which the number of times that each command has been detected is counted for all analyzed commands, and then a specific command is determined based on these values. Furthermore, in the case where the processing has been cancelled (S407) as a result of the determination of the PDL type (S401) having been later judged as being erroneous based on the number of times that the specific command has been detected, whether or not to use this specific command in subsequent confirmation as to the determination of the PDL type (step S403) may be set/changed.

As described above, even in the case where an erroneous determination has been made when selecting the PDL type of print data or where a corresponding PDL type is not supported, if an unexpected command has been issued a fixed number of times during execution of processing, it is possible to suspend the processing and select whether to continue or cancel the processing in accordance with a user input.

### Second Embodiment

Next is a description of the second embodiment according to the present invention. In the first embodiment, PDL analysis processing is performed by the printer. On the other hand, the present embodiment describes a configuration in which the PDL-type determination processing is executed in corporation with a module located on an external network. It should be noted that redundant descriptions that are repetitions of the first embodiment have been omitted.

Processing Flow by Printer

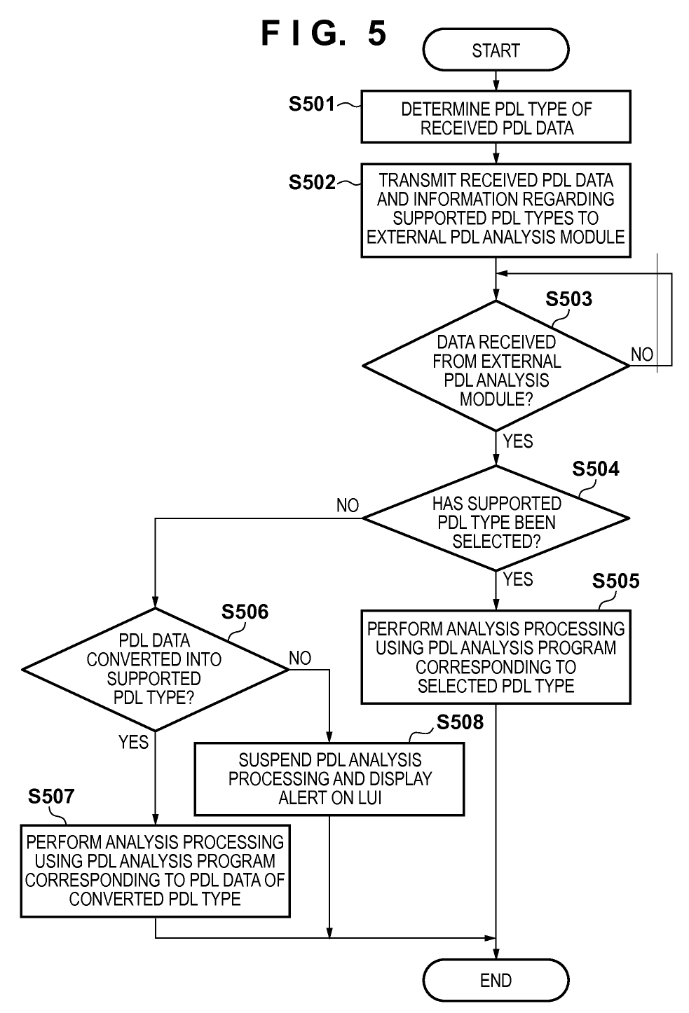

FIG. 5 is a flowchart illustrating a procedure of processing performed by the printer 1002 according to the present embodiment. This procedure is realized by the CPU 11 reading out a program stored in the program ROM 16 or the like serving as a storage unit and executing that program.

First, upon receipt of PDL data, the printer 1002 performs determination processing for determining which one of the aforementioned PDL analysis programs corresponding to the PDL types is to be used to perform processing on the PDL data (S501). If the PDL type determination unit 1007 cannot perform the determination in accordance with a predetermined determination procedure, the printer 1002 transmits the received PDL data and PDL types supported by the printer, to the external PDL analysis module 1005 serving as an external module (S502). Here, “PDL types supported by the printer” means that the printer includes PDL analysis programs corresponding to the PDL types. The printer 1002 then suspends the PDL analysis processing and enters a state in which it stands by for the reception of a result of the determination in response to the notification to the external PDL analysis module 1005 (S503).

After having received the determination result from the external PDL analysis module 1005 (YES in step S503), the printer 1002 determines whether or not one of the PDL types supported by the printer has been selected, based on the determination result (S504). If a PDL type supported by the printer has been selected (YES in step S504), the printer 1002 performs analysis processing using the PDL analysis program corresponding to that PDL type (S505). Thereafter, the procedure ends.

If a PDL type supported by the printer has not been selected (NO in step S504), the printer 1002 confirms whether or not the external PDL analysis module 1005 has transmitted PDL data that was converted into one of the PDL types supported by the printer (S506). If PDL data that was converted into a supported PDL type has been received (YES in step S506), the printer 1002 performs analysis processing on the PDL data using the corresponding PDL analysis program (S507). If a notification indicating that the PDL data cannot be processed has been given from the external PDL analysis module 1005 (NO in step S506), the printer 1002 cancels the analysis processing and displays an alert on the LUI 1008 without executing output processing (S508). Thereafter, the procedure ends.

PDL-Type Determination and Data Conversion by External PDL Analysis Module

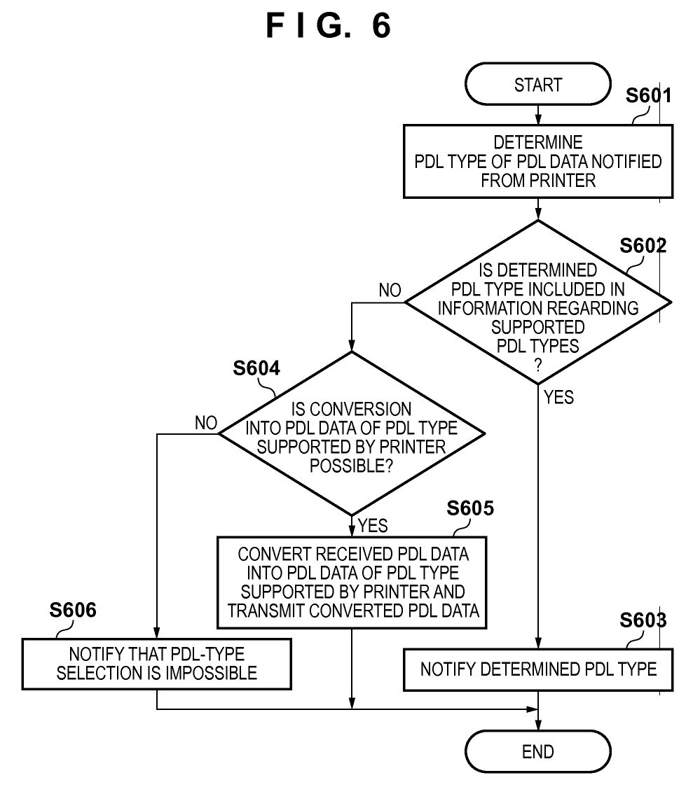

FIG. 6 is a flowchart illustrating a procedure of the determination processing and the data conversion processing performed by the external PDL analysis module 1005 according to the present embodiment. Note that this procedure is realized by the units of an apparatus on which the external PDL analysis module 1005 is mounted.

The external PDL analysis module 1005 analyzes the PDL data notified from the printer 1002 and determines the PDL type (S601). The external PDL analysis module 1005 then performs comparison to determine whether the PDL type determined in step S601 is included in the PDL types supported by the printer, which have been notified from the printer 1002 (S602). If the determined PDL type is supported (YES in step S602), the external PDL analysis module 1005 transmits the selected PDL type as a response to the printer 1002 and ends the processing (S603). If the determined PDL type is not supported (NO in step S602), the external PDL analysis module 1005 analyzes whether or not it is possible to convert the received PDL data of the PDL type into PDL data of one of the PDL types supported by the printer 1002 (S604).

If the conversion is possible (YES in step S604), the external PDL analysis module 1005 performs conversion processing for converting the received PDL data into PDL data of a supported PDL type, and transmits the converted PDL data as a response to the printer 1002 (S605). If the conversion is not possible (NO in step S604), the external PDL analysis module 1005 notifies the printer 1002 of the fact that processing on that PDL data is impossible (S606).

As described above, in addition to the effect of the first embodiment, the present embodiment makes it possible to process PDL data suitable for a printer even if the printer cannot perform determination of the PDL type.

### Third Embodiment

Next is a description of a third embodiment according to the present invention. The present embodiment describes a configuration in which a notification is given to a user who has erroneously transmitted PDL data of a PDL type that is not supported by a printer. It should be noted that redundant descriptions that are repetitions of the first embodiment have been omitted.

Processing Flow

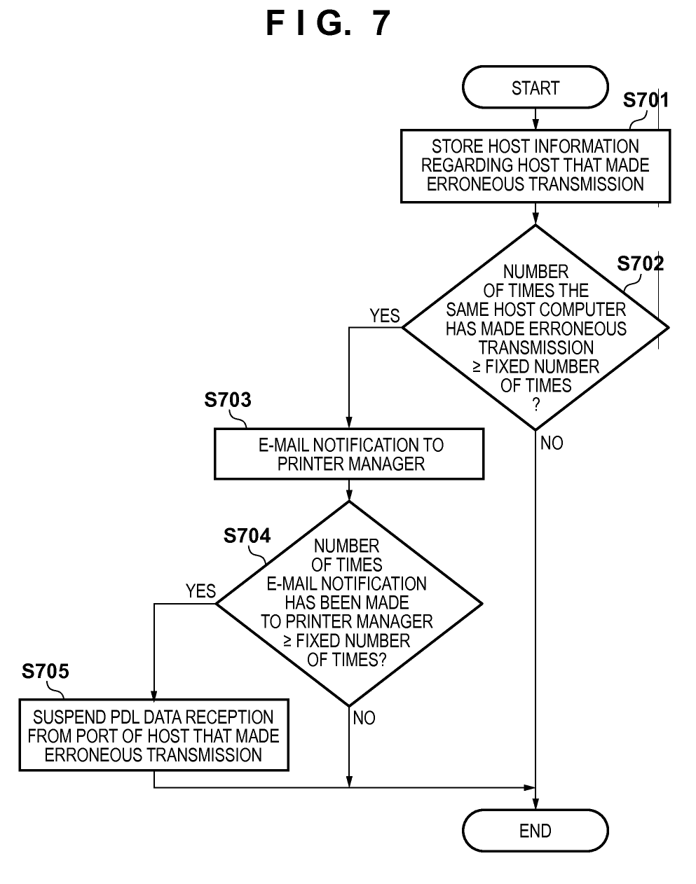

FIG. 7 is a flowchart illustrating a procedure of print processing and processing for storing an expanded image performed by the printer 1002 according to the third embodiment of the present invention. This procedure is realized by the CPU 11 reading out a program stored in the program ROM 16 or the like serving as a storage unit and executing that program.

First, in the second embodiment, if it has been determined that PDL data is of a PDL type that cannot be processed, the printer 1002 stores host information (such as IP address, port, and user) regarding a host computer that has erroneously transmitted the PDL data that cannot be processed (S701). The printer 1002 then determines, based on the stored host information, whether or not the number of times that the same host computer has transmitted an erroneous print job exceeds a predetermined restriction as to the number of erroneous transmissions (S702).

If it has been determined that the number of times that the host computer has made an erroneous transmission is greater than or equal to a predetermined number of times (YES in step S702), the printer 1002 notifies a manager whose e-mail address has been stored in advance, of the host information regarding the host computer that has made an erroneous transmission (S703). In this case, the printer 1002 holds the number of times that a notification has been given, in association with the notified host information (such as IP address, port, and user), in the storage unit.

Next, the printer 1002 determines whether or not the number of times that a notification has been given to the manager is greater than or equal to a predetermined number of times (S704). If the number of times that a notification has been made is greater than or equal to a predetermined value (YES in step S704), the printer 1002 performs processing for suspending the reception of PDL data from the corresponding port, based on the host information regarding the host computer (S705). Note that there are no particular limitations on the method of suspending processing to be used here.

In the present embodiment, the reception of data from the port of a host computer is suspended if the number of times that a notification has been given to a printer manager is greater than or equal to a predetermined threshold value in step S704. However, the present invention is not limited to this. For example, a configuration is also possible in which the reception of data from a corresponding port may be suspended when an e-mail notification is given to a printer manager in step S703.

As described above, in addition to the effects of the first and second embodiments, the present embodiment makes it possible to prevent incorrect output by, for example, giving a notification to a user who has erroneously transmitted PDL data that cannot be processed.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-109614, filed May 16, 2011, which is hereby incorporated by reference herein in its entirety.

What is claimed is:

1. A printing apparatus that performs printing on PDL data described in a page description language, comprising:
a plurality of analysis units configured to correspond respectively to PDL types indicating a plurality of types of page description languages;
a determination unit configured to determine one of the plurality of analysis units to be used for analysis processing, based on a PDL type of the PDL data;
an alerting unit configured, in a case where analysis processing is performed using the analysis unit determined by the determination unit and if the number of times that a specific command has been detected in a predetermined range of the PDL data exceeds a predetermined threshold value, to suspend the analysis processing for the PDL data and to issue an alert;
an accepting unit configured, after an alert has been issued by the alerting unit, to accept an instruction indicating whether to continue or cancel the analysis processing for the PDL data; and
a control unit configured to cancel the analysis processing if the accepting unit has accepted an instruction to cancel the analysis processing for the PDL data.

2. The printing apparatus according to claim 1, further comprising a setting unit configured to set the specific command.

3. The printing apparatus according to claim 1, comprising:
a transmission unit configured, if determination cannot be made by the determination unit, to transmit the PDL data and information regarding the PDL types supported by the printing apparatus to an external module;
a reception unit configured to receive PDL data that has been converted by the external module into a PDL type that can be analyzed by one of the plurality of analysis units; and
an execution unit configured to execute analysis processing using the analysis unit corresponding to the PDL type of the PDL data received by the reception unit.

4. The printing apparatus according to claim 3, wherein if the reception unit has received from the external module a result of determination by an analysis unit capable of analyzing the PDL data, the execution unit executes the analysis processing for the PDL data using the analysis unit based on the determination result.

5. The printing apparatus according to claim 3, wherein if the reception unit has not received PDL data of an analyzable PDL type from the external module, the alerting unit cancels the analysis processing for the PDL data and displays that fact.

6. The printing apparatus according to claim 1, further comprising a holding unit configured to hold, in a storage unit, information regarding a host computer that has transmitted PDL data of a PDL type that is not supported by the plurality of analysis units, and the number of times PDL data of a PDL type that is not supported by the plurality of analysis units has been transmitted.

7. The printing apparatus according to claim 6, further comprising a notification unit configured, if the number of times that the host computer has transmitted PDL data of a PDL type that is not supported by the plurality of analysis units exceeds a predetermined threshold value, to notify a manager of the printing apparatus of the information regarding the host computer.

8. The printing apparatus according to claim 6, further comprising a suspension unit configured, if the number of times that the host computer has transmitted PDL data of a PDL type that is not supported by the plurality of analysis units exceeds a predetermined threshold value, to suspend reception of PDL data from the host computer.

9. A printing system comprising a printing apparatus that performs printing on PDL data described in a page description language; and an external module,
the printing apparatus including:
a plurality of analysis units configured to correspond respectively to PDL types indicating a plurality of types of page description languages;
a transmission unit configured to transmit the PDL data and information regarding the PDL types supported by the printing apparatus, to the external module;
a reception unit configured to receive PDL data that has been converted by the external module into a PDL type that can be analyzed by one of the plurality of analysis units; and
an execution unit configured to execute analysis processing using the analysis unit corresponding to the PDL type of the PDL data received by the reception unit, and
the external module including:
a conversion unit configured to convert the PDL data received from the printing apparatus into PDL data of a PDL type that can be analyzed by the printing apparatus, using the information regarding the PDL types transmitted from the printing apparatus; and
a reply unit configured to transmit the PDL data converted by the conversion unit to the printing apparatus.

10. The printing system according to claim 9, wherein
if the PDL data received from the printing apparatus is described in a PDL type that can be analyzed by the printing apparatus, the replay unit of the external module notifies the printing apparatus of that fact, and
the execution unit of the printing apparatus executes analysis processing using the analysis unit corresponding to the PDL type notified by the external module.

11. A printing method to be used in a printing apparatus that performs printing on PDL data described in a page description language, comprising:
a plurality of analysis steps of performing analysis in correspondence respectively with PDL types indicating a plurality of types of page description languages used to describe PDL data;
a determination step of determining in which one of the plurality of analysis steps analysis processing is to be performed, based on a PDL type of the PDL data;
an alerting step of, in a case where analysis processing is performed in the analysis step determined in the determination step and if the number of times that a specific command has been detected in a predetermined range of the PDL data exceeds a predetermined threshold value, suspending the analysis processing for the PDL data and issuing an alert;
an accepting step of, after an alert has been issued in the alerting step, accepting an instruction indicating whether to continue or cancel the analysis processing for the PDL data; and
a control step of cancelling the analysis processing if an instruction to cancel the analysis processing for the PDL data has been accepted in the accepting step.

12. The printing method according to claim 11, further comprising a setting step of setting the specific command.

13. The printing method according to claim 11, comprising:
a transmission step of, if determination cannot be made in the determination step, transmitting the PDL data and information regarding the PDL types supported by the printing apparatus to an external module;
a reception step of receiving PDL data that has been converted by the external module into a PDL type that can be analyzed in one of the plurality of analysis steps; and
an execution step of executing analysis processing using the analysis step corresponding to the PDL type of the PDL data received in the reception step.

14. The printing method according to claim 13, wherein if the reception step has received from the external module a result of determination in an analysis step capable of analyzing the PDL data, the execution step executes the analysis processing for the PDL data using the analysis step based on the determination result.

15. The printing method according to claim 13, wherein if the reception step has not received PDL data of an analyzable PDL type from the external module, the alerting step cancels the analysis processing for the PDL data and displays that fact.

16. The printing method according to claim 11, further comprising a holding step of holding, in a storage unit, information regarding a host computer that has transmitted PDL data of a PDL type that is not supported in the plurality of analysis steps, and the number of times PDL data of a PDL type that is not supported in the plurality of analysis steps has been transmitted.

17. The printing method according to claim 16, further comprising a notification step of, if the number of times that the host computer has transmitted PDL data of a PDL type that is not supported in the plurality of analysis steps exceeds a predetermined threshold value, notifying a manager of the printing apparatus of the information regarding the host computer.

18. The printing method according to claim 16, further comprising a suspension step of, if the number of times that the host computer has transmitted PDL data of a PDL type that is not supported in the plurality of analysis steps exceeds a predetermined threshold value, suspending reception of PDL data from the host computer.

19. A printing method to be used in a printing system including a printing apparatus that performs printing on PDL data described in a page description language, and an external module, comprising:
a plurality of analysis steps of performing analysis in correspondence respectively with PDL types indicating a plurality of types of page description languages used to describe PDL data;
a transmission step of transmitting the PDL data and information regarding the PDL types supported by the printing apparatus, to the external module;
a reception step of receiving PDL data that has been converted by the external module into a PDL type that can be analyzed in one of the plurality of analysis steps; and
an execution step of executing analysis processing in the analysis step corresponding to the PDL type of the PDL data received in the reception step,
the plurality of analysis steps, the transmission step, the reception step, and the execution step being performed by the printing apparatus, and
the method further comprising:
a conversion step of converting the PDL data received from the printing apparatus into PDL data of a PDL type that can be analyzed by the printing apparatus, using the information regarding the PDL types transmitted from the printing apparatus; and
a reply step of transmitting the PDL data converted in the conversion step to the printing apparatus,
the conversion step and the replay step being performed by the external module.

20. A computer readable medium storing a program for causing a computer to function as:
a plurality of analysis units configured to correspond respectively to PDL types indicating a plurality of types of page description languages;
a determination unit configured to determine one of the plurality of analysis units to be used for analysis processing, based on a PDL type of the PDL data;
an alerting unit configured, in a case where analysis processing is performed using the analysis unit determined by the determination unit and if the number of times that a specific command has been detected in a predetermined range of the PDL data exceeds a predetermined threshold value, to suspend the analysis processing for the PDL data and to issue an alert;
an accepting unit configured, after an alert has been issued by the alerting unit, to accept an instruction indicating whether to continue or cancel the analysis processing for the PDL data; and
a control unit configured to cancel the analysis processing if the accepting unit has accepted an instruction to cancel the analysis processing for the PDL data.
